(19) United States
(12) Patent Application Publication
(10) Pub. No.: US 2015/0316104 A1
(43) Pub. Date: Nov. 5, 2015

(54) PEDESTAL BEARING HOUSING

(71) Applicant: SCHAEFFLER TECHNOLOGIES AG & CO. KG, Herzogenaurach (DE)

(72) Inventors: Waldemar Schulz, Schweinfurt (DE); Martin Grehn, Dittelbrunn (DE)

(73) Assignee: SCHAEFFLER TECHNOLOGIES AG & CO. KG, Herzogenaurach (DE)

(21) Appl. No.: 14/650,396

(22) PCT Filed: Sep. 6, 2013
(86) PCT No.: PCT/DE2013/200160

§ 371 Date: Jun. 8, 2015

(30) Foreign Application Priority Data
Dec. 10, 2012 (DE) 10 2012 222 595.1

(51) Int. Cl. F16C 35/02; F16C 35/04

(52) U.S. Cl. CPC F16C 35/02; F16C 35/047

(57) ABSTRACT

A pedestal bearing housing with a housing lower part and a housing upper part and a hole, which is formed by the housing lower part and the housing upper part, for receiving a bearing, with the housing lower part and the housing upper part each forming a circumferential section of the hole, and with a stand surface formed on a bottom side of the housing lower part. According to the invention, it is provided that the bottom side has a recess interrupting the stand surface, wherein the recess is described by an exclusively curved profile in a cross-sectional representation of the pedestal bearing housing perpendicular to a center axis of the hole.

### FIELD OF THE INVENTION

The invention relates to a pedestal bearing housing with a housing lower part and a housing upper part and an opening formed by the housing lower part and the housing upper part for holding a bearing, the housing lower part and the housing upper part each form a peripheral section of the opening, and with a stand surface formed on a bottom side of the housing lower part.

### BACKGROUND

Pedestal bearing housings are often used to hold shafts by bearings, such as swivel-joint roller bearings, ball-joint bearings, or cylinder roller bearings, so that they can rotate relative to a component. The pedestal bearing housings are here mounted, typically screwed, with their stand surface on a mounting surface of the component. The bearing is inserted directly into the (rotationally symmetrical) opening of the pedestal bearing housing or else inserted into the pedestal bearing housing via clamping sleeves. Divided pedestal bearing housings have a housing upper part (cover) that can be removed from the housing lower part and that can be centered by means of clamping pins, and both components typically form a half shell for holding the bearing or the clamping sleeve, i.e., they each form half of the opening.

From DE 195 43 114 A1 it is known, for one-part bearing housings, to provide a slot in a loaded area in the lower housing section, so that an approximately ideal load distribution is produced on the rolling bodies. This slot that is provided especially for one-part bearing housings and wraps around the hole holding the roller bearing in an angle of 180 degrees is complicated to form in the bearing housing.

### SUMMARY

The present invention is based on the objective of providing a pedestal bearing housing according to the class that provides an improved load distribution within the bearing and is simple and economical to produce or to assemble.

This objective is met by a pedestal bearing housing according to the independent claim. Consequently, a pedestal bearing according to the class is characterized in that the lower side has a recess interrupting the stand surface, wherein the recess is described by a curved profile in a cross-sectional representation of the pedestal bearing housing standing perpendicular to a center axis of the hole.

Therefore, the entire stand surface of the housing lower part no longer contacts a mounting surface of a machine part, but instead is supported on a mounting surface by means of, for example, two surface sections separated by the recess. This is achieved by the targeted removal of material on the lower side.

The recess can be generated in a casting process (e.g., metal) or injection molding process (e.g., plastic) by corresponding shaping of the tool mold. Alternatively or additionally, the final shape of the recess could be formed by cutting processing. The latter option allows the recess according to the invention to also be formed at a later time in an already existing pedestal bearing housing. The shape and size of the recess could also be adapted to the specific use case and thus different recesses could be formed in identical pedestal bearing housings during production; production and storage are improved.

Finally, the reduced stand surface also reduces the costs of the processing for this surface. The necessary fine processing (e.g., grinding) can be performed more quickly and more economically.

The curved profile of the recess leads to another improvement of the pressure distribution and also reduction of stress peaks in the housing lower part. The curved profile can be described by a constant curvature (e.g., section of a circle) or by a changing curvature (e.g., logarithmic, spline curves, etc.). Advantageously, the largest possible percentage of the recess is described by a curved profile (viewed in the cross-sectional representation). It is conceivable, for example, to connect the recess starting from two end points of the recess in the cross-sectional representation essentially by a circular arc with constant curvature that is displaced slightly in the direction of the hole, however, by a straight line section at each end point.

Advantageously, both the housing upper part and the housing lower part are formed in one piece—but it would also be conceivable for them to have a multiple-part construction.

The pedestal bearing housing according to the invention can be used both for roller bearings and also for sliding bearings.

Preferred embodiments are specified in the dependent claims.

If, according to one construction variant, the housing upper part and the housing lower part are connected to each other integrally, this reduces the production costs.

In one embodiment it is provided that the recess is described by an exclusively curved profile in a cross-sectional representation of the pedestal bearing housing standing perpendicular to a center axis of the hole. In this embodiment, the recess in the cross-sectional representation thus has no straight surface sections, which leads to a still noticeable improvement of the pressure distribution and further reduction of stress peaks in the housing lower part.

According to one embodiment it is provided that the recess is described by a section of a circular arc in a cross-sectional representation of the pedestal bearing housing standing perpendicular to a center axis of the hole. Advantageously, the center point of the circular arc is outside of the pedestal bearing housing and/or the circular arc is positioned symmetrically below the hole in the cross-sectional representation.

A good pressure distribution is produced in the bearing when it is provided that a maximum opening angle in a cross-sectional representation of the pedestal bearing housing standing perpendicular to a center axis of the hole is 60 degrees, advantageously between 20 to 60 degrees, between two end points of the recess with respect to a center point of the hole.

Simultaneously, this produces a good compromise between improving the pressure distribution and maintaining the stability of the pedestal bearing housing for a ratio of the diameter of the recess (diameter of the circular arc of the recess in cross section) with respect to the diameter of the hole between 0.2:1 to 1.5:1, advantageously between 0.8:1 and 1.4:1.

A good improvement of the pressure distribution is produced when it is provided that a width of the recess in a cross-sectional representation of the pedestal bearing housing standing perpendicular to a center axis of the hole is less than a width of the hole, advantageously, a ratio of the width of the recess to the width of the hole is 0.1:1 to 0.5:1, advantageously 0.2:1 and 0.4:1. The width of the hole here corresponds to the diameter of the hole.

Pedestal bearing housings often have a significantly smaller length (extent measured along the center axis of the hole) than width (extent measured perpendicular to the center axis of the hole). In this case, an extent of the recess over the entire length of the pedestal bearing housing is the most significant for optimizing the pressure distribution. According to one embodiment, it is therefore provided that the recess extends in the direction of a center axis of the hole over the entire stand surface, advantageously with a constant cross-sectional profile. Instead of a constant cross-sectional profile, the recess could also extend along the center axis with a changing cross-sectional profile.

For most use cases, a symmetric arrangement of the recess below the hole is the most advantageous, i.e., when it is provided that, in a cross-sectional representation of the pedestal bearing housing standing perpendicular to a center axis of the hole, the recess is arranged centrally below the hole. Such a symmetric arrangement is optimal for forces acting on the pedestal bearing housing radially in the direction of the stand surface.

However, if radial force components perpendicular to the stand surface must be accounted for, it can be provided that, in a cross-sectional representation of the pedestal bearing housing standing perpendicular to a center axis of the hole, the recess is arranged eccentrically below the hole. For changing radial force components in both directions perpendicular to the stand surface, a second recess constructed on the lower side and interrupting the stand surface can be provided, wherein the second recess is described by an exclusively curved profile in a cross-sectional representation of the pedestal bearing housing standing perpendicular to a center axis of the hole.

Unequal magnitude radial force components in both directions perpendicular to the stand surface could also be taken into account in that the recess or the second recess has a non-mirror-inverted profile in a cross-sectional representation of the pedestal bearing housing standing perpendicular to a center axis of the hole.

The pedestal bearing housing can be made from metal or plastic. It is also conceivable that the housing upper part is made from a different material than the housing lower part. It is also possible that the housing upper part is formed by a sheet metal cap or a plastic cap.

### BRIEF DESCRIPTION OF THE DRAWINGS

Embodiments of the present invention are explained below with reference to the accompanying figures. Shown are

FIGS. 1, 2 a pedestal bearing housing according to the prior art,

FIGS. 3, 4 a first embodiment of a pedestal bearing housing according to the invention,

FIG. 5 a second embodiment of a pedestal bearing housing according to the invention,

FIG. 6 a third embodiment of a pedestal bearing housing according to the invention, and

FIG. 7 a fourth embodiment of a pedestal bearing housing.

### DETAILED DESCRIPTION OF THE PREFERRED EMBODIMENTS

Identical or functionally identical elements are designated by identical reference symbols in the figures.

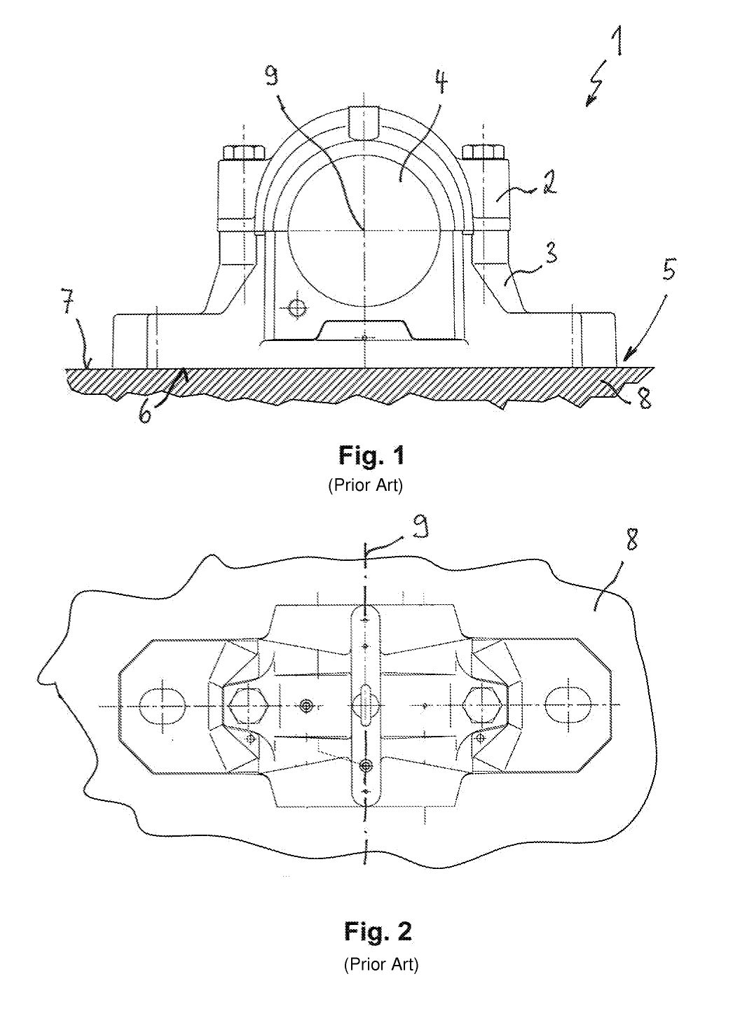

FIGS. 1 and 2 show a two-part pedestal bearing housing 1 according to the prior art in a front view (FIG. 1) and a representation from above (FIG. 2). The pedestal bearing housing comprises a housing upper part 2 and a housing lower part 3, as well as a hole 4 formed by this parts for holding a not-shown bearing. The housing upper part 2 and the housing lower part 3 each form peripherally the halves of the hole 4.

The housing lower part 3 stands on a mounting surface 7 of a machine part 8 supporting the pedestal bearing 1 by means of a stand surface 6 formed on a bottom side 5 and is screwed to this. The stand surface 6 formed on the entire bottom side 5 of the housing lower part 3 contacts the machine part 8.

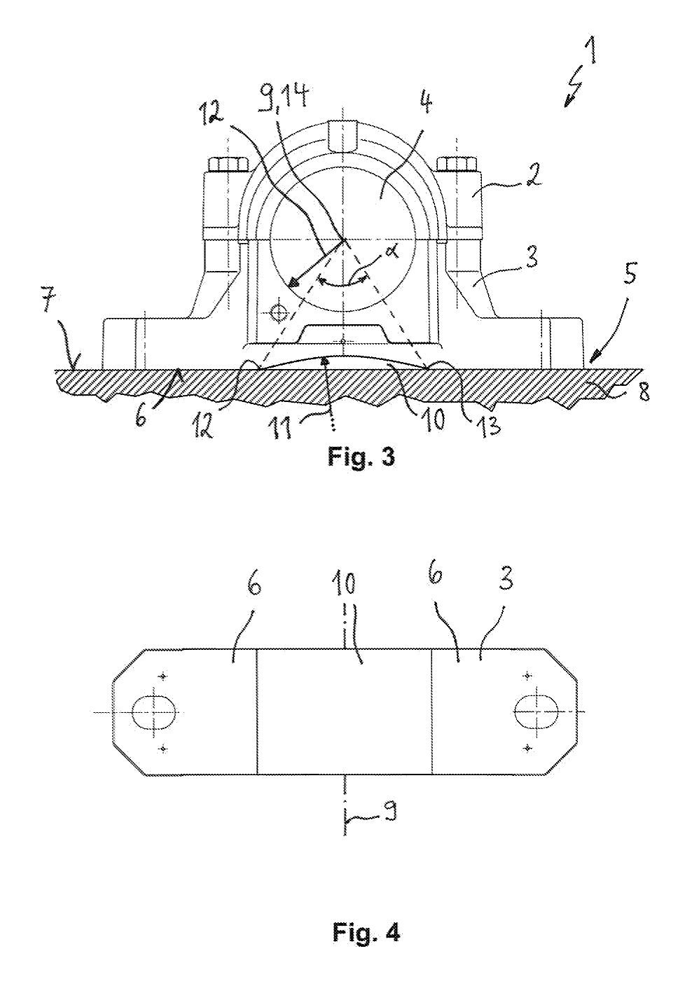

A first embodiment of the invention is shown in FIG. 3 (top view) and 4 (representation from below).

On the bottom side 5 of the housing lower part 3, a recess 10 running in the longitudinal direction of the center axis 9 of the hole 4 is formed. The recess 10 here runs over the entire width of the pedestal bearing housing 10 and has a constant cross-sectional profile along its extent over the width of the pedestal bearing housing 10.

The cross-sectional profile—to be seen in FIG. 3—is described by a section of a circular arc. The—not-shown—center point of the circular arc is outside of the pedestal bearing housing 1 and the radius 11 of this circular arc is approximately 1.5 times as large as the radius 12 of the hole 4. An opening angle α measured between two end points 12, 13 of the recess 10 with respect to a center point 14 of the hole 4 equals approximately 50 degrees in this embodiment.

The recess 10 divides the stand surface 6 into two equal size surface sections.

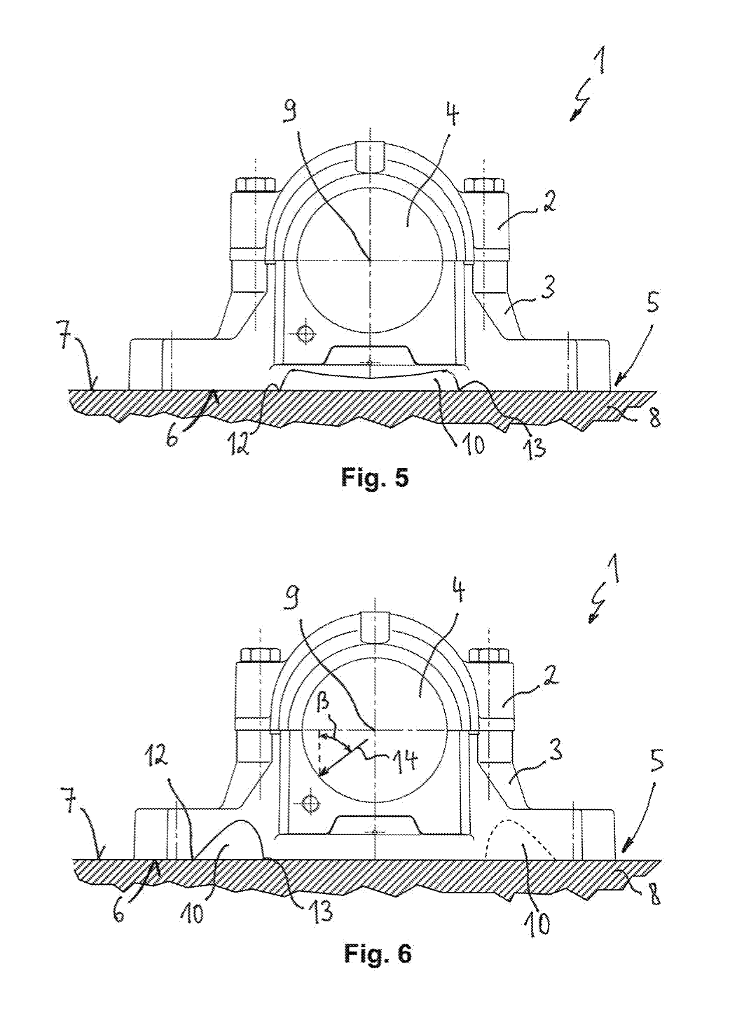

In FIG. 5, a second embodiment of the invention is shown. The recess 10 arranged centrally with respect to the width of the pedestal bearing housing 1 is described by a sequence of circular arcs, wherein the cross-sectional profile shown in FIG. 5 is continuous.

FIG. 6 shows a third embodiment. This time, a recess 10 arranged eccentrically with respect to the width of the pedestal bearing housing 1 is provided on the left side. This recess 10 can receive, in an optimal way, radial forces on the bearing located in the hole 4, which do not contact the stand surface 6 at a right angle, but instead at an angle β. The second embodiment is thus designed for a preferred direction of the radial force. If changing radial forces that, however, also contain a large perpendicular force component (radial force parallel to the stand surface) must be accounted for, a second recess could also be provided in the stand surface. Such a second recess is shown with a dashed line in FIG. 6 on the right side.

Advantageously, the edges are rounded by transitioning radii to the stand surface 6 at the end points 12, 13 in each embodiment.

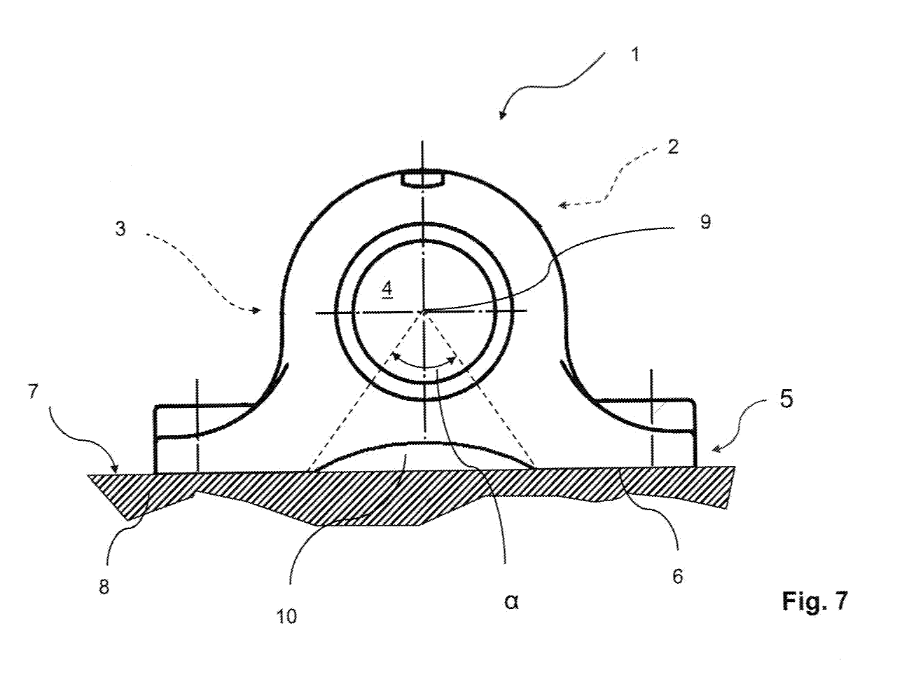

In FIG. 7, a pedestal bearing housing 1 is shown, wherein, in this variant, the housing upper part 2 forming this pedestal bearing housing 1 and the housing lower part 3 are connected to each other integrally. A hole 4 for holding a bearing (not shown) is provided between the housing parts 2, 3 connected to each other integrally.

In this variant, the bottom side 5 of the pedestal bearing housing 1 is also provided with a stand surface 6 with which the pedestal bearing housing 1 can be connected to a mounting surface 5 of a machine part 8 supporting the pedestal bearing housing 1.

On the bottom side 5 of the one-part pedestal bearing housing 1, in the longitudinal direction of the center axis of the hole 4, a recess 10 is formed that corresponds essentially to the section of a circular arc, wherein the center point of the circular arc is outside of the pedestal bearing housing 1 on the pedestal bearing center axis running vertical through the center point 9.

It is understood that the variant according to FIG. 7 is not limited to a circular arc-shaped recess 10, but instead can also be equipped with recesses 10 with other shapes—as shown, for example, in FIGS. 5 and 6.

### LIST OF REFERENCE NUMBERS

1 Pedestal bearing housing

2 Housing upper part

3 Housing lower part

4 Hole

5 Bottom side

6 Stand surface

7 Mounting surface

8 Machine part

9 Center axis of the hole

10 Recess

11 Radius

12 End point

13 End point

14 Radial force

α Opening angle

β Radial force angle

1. A pedestal bearing housing comprising a housing lower part and a housing upper part and a hole formed by the housing lower part and the housing upper part for holding a bearing, the housing lower part and the housing upper part each form a peripheral section of the hole, and a stand surface formed on a bottom side of the housing lower part, the bottom side has a recess interrupting the stand surface, and the recess has a curved profile in a cross-sectional representation of the pedestal bearing housing standing perpendicular to a center axis of the hole.

2. The pedestal bearing housing according to claim 1, wherein the housing upper part and the housing lower part form an integral unit.

3. The pedestal bearing housing according to claim 1, wherein the recess is formed exclusively by the curved profile in the cross-sectional representation of the pedestal bearing housing standing perpendicular to the center axis of the hole.

4. The pedestal bearing housing according to claim 1, wherein the recess is described by a section of a circular arc in the cross-sectional representation of the pedestal bearing housing standing perpendicular to the center axis of the hole.

5. The pedestal bearing housing according to claim 4, wherein a ratio of a diameter of the recess to a diameter of the hole is between 0.2:1 to 1.5:1.

6. The pedestal bearing housing according to claim 1, wherein a maximum opening angle α between two end points of the recess in the cross-sectional representation of the pedestal bearing housing standing perpendicular to the center axis of the hole is 120 degrees with respect to a center point of the hole.

7. The pedestal bearing housing according to claim 1, wherein a width of the recess in the cross-sectional representation of the pedestal bearing housing standing perpendicular to the center axis of the hole is less than a width of the hole.

8. A pedestal bearing housing according to claim 1, wherein the recess extends in a direction of the center axis of the hole over an entire stand surface.

9. The pedestal bearing housing according to claim 1, wherein the recess is arranged centrally below the hole in the cross-sectional representation of the pedestal bearing housing standing perpendicular to the center axis of the hole.

10. The pedestal bearing housing according to claim 1, wherein the recess is arranged eccentrically below the hole in the cross-sectional representation of the pedestal bearing housing standing perpendicular to the center axis of the hole.

11. The pedestal bearing housing according to claim 1, further comprising a second recess formed on the bottom side and interrupting the stand surface, the second recess has an exclusively curved profile in a cross-sectional representation of the pedestal bearing housing standing perpendicular to the center axis of the hole.

12. The pedestal bearing housing according to claim 11, wherein the recess and the second recess have a non-mirror-inverted profile, respectively, in the cross-sectional representation of the pedestal bearing housing standing perpendicular to the center axis of the hole.

13. The pedestal bearing housing of claim 7, wherein a ratio of the width of the recess to the width of the hold is 0.1:1 to 0.5:1.
